(19) United States
(12) Patent Application Publication
(10) Pub. No.: US 2009/0244698 A1
(43) Pub. Date: Oct. 1, 2009

(54) MICROSCOPE COMPRISING AT LEAST TWO COMPONENTS

(76) Inventor: Reto Zust, Widnau (CH)

Correspondence Address: ALEXANDER R SCHLEE;SCHLEE IP INTERNATIONAL P.C., 3770 HIGHLAND AVENUE, SUITE 203, MANHATTAN BEACH, CA, 90266, US

(21) Appl. No.: 12/364,941

(22) Filed: Feb. 3, 2009

(30) Foreign Application Priority Data
Mar. 28, 2008 (DE) 102008000879.6-56
Mar. 28, 2008 (DE) 202008004271.2

(51) Int. Cl. G02B 21/00

(52) U.S. Cl. 359/368

(57) ABSTRACT

A microscope comprising at least two components is suggested, wherein each of the at least two components comprises at least one trigger interface, and each of the at least one interfaces is configurable at least as an input and an output. Further, a microscopy method using such a microscope is suggested comprising the appropriate configuring of trigger interfaces of the various components and then continuously moving a microscope stage and continuously moving a focusing drive from a first focus position to a second focus position while simultaneously acquiring images by means of an apparatus for image acquisition.

### CROSS-REFERENCE TO RELATED APPLICATIONS

This application claims the priority of the German patent application DE 102008000879.6 having a filing date of Mar. 28, 2008 and the German Utility Model 202008004271.2 having a filing date of Mar. 28, 2008, the entire content of both prior applications is herewith incorporated by reference.

### BACKGROUND OF THE INVENTION

The present invention relates to a microscope having at least two components, and to use of such a microscope for microscopy.

Digital technology has already been making inroads into microscopy for some time. Many of the advantages offered by this technology can accordingly be utilized when working with microscopes. Both standard products and many specialized individual solutions have been created for the general application area of microscopy.

Digital microscopy, in particular for automated microscopes, encompasses microscope components that as a rule can be coded, regulated, or controlled; a device for image acquisition, usually a camera; a device for communication between the units; a control program to control execution sequences, for example during image acquisition and storage; and an application software program for image evaluation. These constituents are described below in further detail. With regard to the physical structure of a motorized microscope, the reader may be referred to the Applicant's DE 102 49 177.

In microscopy, a specimen is illuminated in order to make its characteristic features visible. A distinction is made between incident and transmitted illumination. In addition, depending on the application, different contrasting methods can be used with or without contrast staining using coloring agents. Usual contrasting methods are bright field, dark field, fluorescence, phase contrast or differential interference contrast (DIC), polarization, and total internal reflection fluorescence (TIRF). The various contrasting methods are also used in combination, depending on the application.

To generate an image of the specimen, an optical system having a fixed, stepwise adjustable, or steplessly adjustable magnification is used in a microscope. As a rule, a digital microscope also possesses an apparatus for viewing the image with the human eye with the aid of the eyepiece. For image production, the generated image is imaged onto the detector of a camera, presented on a monitor, and then further processed. The camera is typically a matrix area detector using CCD or CMOS technology. By subsequent amplification, filtration (optically and digitally) and digitization, the image is processed into a data format suitable for further processing, presentation, or storage. “Image data” are understood hereinafter as an image digitized in this fashion. In rare cases, however, eyepieces are entirely dispensed with and the microscope possesses only (an) apparatus(es) for image acquisition. In all other cases, the possibility must exist of distributing the light quantity, inside the apparatus for image generation, to the various microscope outputs (visual output, one or more camera outputs) at an adjustable or fixed ratio, including simultaneously. As a rule, each microscope output possesses different optical properties, in which case the microscope or the apparatus for image generation then comprises multiple optical paths that are embodied in partly or entirely separate fashion. By controlled modification of the settings and properties of these optical paths, the optical properties of the individual microscope outputs can be modified individually, in groups, or together. Reference may be made in this context, for example, to the Applicant's DE 103 61 158 A1.

For complete understanding and for the interpretation of stored images, data regarding image generation and image acquisition, and values derived therefrom, must also be available for further processing, presentation and storage in addition to the image data. Data regarding image generation are, for example: magnification, numerical aperture, working distance, and focal length of the objective(s) used; position of the objective changer; magnification of the zoom and its range; magnification factor of interposed accessories (coaxial illumination, magnification changer, etc.); type, magnification factor, and position of a changeover apparatus for the optical output of the tube; magnification and field-of-view number of the eyepieces; magnification factor of the video objective(s); operating states of the illumination apparatus (intensity/brightness), color temperature, diaphragm settings; spectral, polarizing, and gray filters used, and settings of the shutters and the spectral and polarizing filters during image generation. Variables derived therefrom are, for example: optical resolution of the image-generating optics, image field size, object field size, depth of focus, and perspective in the case of stereomicroscopes. Data regarding the apparatus for image acquisition are, for example: digital resolution of the area detector, electronic gain, detector size, operating mode (binning, high-sensitivity binning, etc.), exposure time, color saturation. Information regarding the position of the specimen with respect to the microscope is also significant. Typical data of this kind are the lateral position of the displayed specimen region relative to the optical axis (for example when an XY stage is used), and the axial position of the displayed specimen region relative to the focus plane. In addition, it is often useful to have information about the configuration and operating states of the microscope, together with the image data, permanently available in a so-called image data record.

In a motorized and coded microscope, position and movement sensors having corresponding evaluation electronics are used in the microscope components in order to detect these states and calculate the information. These are typically pulse generators, light barriers, magnetic sensors, potentiometers, or stepping motor step counters. The Applicant's DE 102 49 904 A1 describes the use of transponders to detect the states of, in this case, filters. The state of the apparatus for image acquisition can also be read out and adjusted by the control electronics by means of corresponding software. In the case of a purely manual unit, these states and data can be acquired by way of user inputs. For a large area of application of digital microscopy, it is additionally possible to acquire further information regarding the specimen or in conjunction with image acquisition. This information can, for example, be inputted manually by the operator, scanned in (e.g. using a barcode reader or transponder), or can exist in the form of sound recordings (description of specimen, patient's name, diagnosis, etc.) or can be stored automatically (date and time of image acquisition, user name, etc.).

Display of the information described in the above paragraphs regarding image generation and image acquisition allows the user to make specific modifications so that the desired result is achieved in terms of image generation and image acquisition. These modifications can be made by way of corresponding operating elements on the microscope (rotary knobs, sliders, switches, pushbuttons, scroll wheels, adjusting levers, touch-sensitive display elements, etc.). These operating elements can also produce a direct mechanical adjustment. These operating elements can likewise be equipped with sensors, and can be housed in an integrated or external operating unit. The signals of these sensors are processed and forwarded to the corresponding actuating elements (DC, AC, or stepping motors, electronic switches, electromechanically operated levers and cylinders, piezoactuators, etc.) in order to adapt the settings or the operating state of the microscope in accordance with the user's inputs. This is then referred to as a partly or entirely motorized microscope. In addition to the operating elements, other components of the microscope can also modify the settings or the operating state of a component.

A typical example thereof is automatic adaptation of the brightness of the illumination apparatus, upon a change in the settings of the apparatus for image generation (modified magnification, diaphragm setting, numerical aperture, filters, etc.), by modifying the intensity/brightness, diaphragm settings, or gray filters, (cf. the Applicant's DE 10 2004 056 685 A1 and DE 10 2006 022 073 A1). The purpose of this automatic brightness adaptation is to provide a generated image having a brightness distribution that is as constant as possible, the average brightness over the image generally being the criterion. Two procedures for controlling the illumination apparatus are known.

On the one hand, the present brightness can be detected (e.g. using the area detector in the apparatus for image acquisition or a spot detector in the apparatus for image generation). Based on this present brightness value, a determination can be made as to how the properties of the illumination unit must be modified in order to achieve the desired brightness value.

The second procedure is to use the present optical properties of the apparatus for image generation, based on their states and settings, in order to calculate the theoretically existing brightness values of the image data, or other suitable auxiliary values. Based on the discrepancy that exists with respect to the desired brightness, or its auxiliary value, the necessary adjustments to the apparatus for image generation can then be made automatically.

With both procedures, instead of an automatic adjustment the user can also be informed (visually, acoustically, etc.) as to how the apparatus for image generation must be adjusted in order to achieve the desired brightness values for the image data. With both procedures, the viewer's visual image can also be considered instead of the image data. The definition of the desired brightness value can once again be preset, or can be effected in modifiable fashion by the user by means of an input apparatus (operating unit or PC). Just as modification of the settings of the illumination apparatus can be used for brightness adaptation, the same can also be accomplished by way of the settings of the apparatus for image acquisition (e.g. exposure time, gain, imaging mode) and for image generation (e.g. diaphragms, gray filters).

A further example of how the properties of the components of a digital microscope can be mutually adjusted automatically is the dependence of the displacement speed of an XY stage on the object field size of the apparatus for image generation. For this, the change in object field size (usually by way of a change in magnification) is monitored, and a low speed is used for a small object field and a higher speed for a large object field. The dependence of speed on object field size can be linear, quadratic, exponential, logarithmic, or governed by another mathematical function.

A similar dependence also exists between the depth of focus of the apparatus for image generation and the displacement speed of the focusing drive. Operating convenience during focusing can be substantially enhanced by a controlled modification in speed. The sensitivity of the operating elements for controlling movement of the XY stage and of the focusing drive can also be influenced in the same fashion. Depending on the application, it is also necessary to switch off this automatic adaptation of speeds, for example in order to travel at a constant speed, for example for coarse navigation or in order to load and unload the specimen stage. Switchover of these operating modes (automatic speed, fixed or adjustable speed) can typically be performed by actuation of an operating element by the user, or can be a constituent of a fixed operating sequence.

As a result of new functionality or error resolution in the software of one or more components of the microscope, it may be necessary to update the software of that/those component(s). The version of each component of the microscope is checked by another component, or by an operating software program on the PC, to ascertain the component in which software needs to be updated in order to guarantee optimal or new functionality. The check can be, for example, a constituent of the starting process, can be performed periodically, or can be carried out upon user request. Based on an indication of the software version of each component of the microscope, the user can furthermore decide whether an update is necessary or possible. A further possibility for checking whether a software version is up to date involves use of a centralized software catalog. This can be located, for example, on a PC connected to the microscope, or on a Web server of the microscope manufacturer, or can be held by a third-party supplier authorized by the manufacturer. If an Internet connection is available, the software versions can thus be checked by means of said Web server and updated as applicable. A number of procedures for this updating process are conceivable. One secure possibility is to transfer the software from the software catalog into a protected region of the program memory of the processor of the component to be updated. Since this transfer can occur via a serial bus, the process takes a few seconds to minutes. Only as a last step is the software copied into the region used by the processor for the application software. This process can as a rule be carried out very quickly. This procedure offers the advantage that an interruption during transfer from the software catalog has no influence on the functionality of the component. An interruption can be caused by the user, or by an interruption in power delivery. Upon a subsequent restart of the component, the original (not yet updated) copy of the software is used. The starting process can also contain a consistency check of the application software. If the test fails, the user can be informed and/or an attempt can be made to use, for reconstruction, the copy of the software originally present for software updating purposes in the protected region of the program memory.

Various operating states of different microscope components may also be mutually exclusive because of functional or safety-related requirements. One example of a safety-related requirement is that the shutter of an illumination apparatus for fluorescence must not be capable of being opened if there is no emitter filter in the beam path. Reference is made in this regard, for example, to the Applicant's DE 102 49 904 B4. For functional reasons, for example, certain settings of the objective changer may also be excluded when a specific contrasting method is selected; this is typically the case with differential interference contrast (DIC).

Selection of a contrasting method can usually also initiate a change in the properties of other components of the microscope. For example, diaphragm and shutter settings can be adjusted accordingly, or the shutters of another illumination apparatus, not required for that contrasting method, can be closed. For certain contrasting methods, filters are also introduced into or removed from the apparatus for image generation. The polarizing and analyzing filters required for polarization, for example, are automatically introduced.

In addition to these two reasons for mutual influencing of the operating states of components of a microscope, there are also reasons associated with the particular application of the microscope. Transmitted and fluorescent illumination modes, for example, are often utilized in rapid alternation. It is therefore highly advisable that, upon actuation of the operating element for opening and closing one of the two shutters, the shutter of the other illumination apparatus be opened or closed alternately or concurrently. Instead of the shutters, the lamps can also be actuated in the same fashion.

Centralized or partly or entirely distributed display, operating, evaluation, and control units are a prerequisite for mutual influencing. In the latter case, communication typically occurs via an electronic communication interface (RS-232, RS-422, CAN, IEEE 1394, USB, Ethernet, Bluetooth, WLAN, etc.), as also described, for example, in the Applicant's DE 102 49 177 A1. In a distributed system, the advantages of a bus system prevail. The essential advantage is that a component of the microscope can, by itself, send a change in its operating states or properties out onto the bus. Every other component (operating, evaluation, and control units) can sense and further process that change. In the case of a display unit, this can be an update of the display. The control unit can thereby adapt the control parameters (e.g. adapt the speed of the focusing drive upon a change in object field size). In the case of an operating unit, the sensitivity of the operating elements can thereby be adapted. The protocol used for communication can also contain, in addition to a identifier to identify the sender, an identifier to identify the receiver or receiver group. Messages transmitted on the bus can thus be addressed in targeted fashion. This prevents a component from unnecessarily using computing power to process irrelevant messages. If the protocol for polling the properties and states is uniform for all components, all components or groups of components can be polled with one query. For example, the identifier (name) of every component can be requested by sending out a query addressed to all components. Each component replies independently to that query.

A large number of possibilities are conceivable for using the information so far described with regard to image data. One obvious way of using them is to present the information. Presentation on a display (PC screen, display on the microscope, external display) can occur simultaneously with or independently of the image data. Presentation by way of a predetermined screen mask or one freely configurable for one or more users (form, list, table, tree structure) is possible. The data for one or more image data records can also be presented simultaneously. Also known is the use of low-resolution preview images, lists, tables, or tree structures representing individual information items of multiple image data records, and display of the complete image data or information item after selection by means of said preview images, list or table entries, or tree structure entries. For the display of these preview images, lists, or tables, filters could also be applied to individual information items in a manner sufficiently known from database technology. It is also known that the information items and image data can be transferred to predefined report templates (e.g. Microsoft Word templates). This can once again be implemented in preset fashion, or in a manner configurable by the user. The report data can be embedded or merely referenced. The latter approach has the advantage that no data are duplicated, and that changes are immediately updated at every location at which they are used or presented.

The properties and operating states of the apparatus for image generation and image acquisition can be stored both together with the associated image data, or without image data. In the latter case, storage can be effected in one component or in distributed fashion in the individual components (e.g. stage position in the stage, focusing drive position in the focusing apparatus, etc.), and can be logically related by means of a shared reference (e.g. memory location number). The values thus stored can be associated with an operating element (pushbutton, rotary knob, switch, scroll wheel, touch-sensitive display element, etc.) of the microscope or with a PC software program, or can be available as a selection list. By actuation of the operating element or by selection of an entry in this selection list, the stored properties and operating states are set in the microscope components. Those properties and operating states that are referenced next (e.g. the respectively next memory location number) can be set by actuating the operating element again. It is also known that the properties and operating states to be restored can be selected on the basis of the associated image data (cf. in this context the Applicant's DE 10 2005 053 703 A1).

Because of safety-related requirements or application requirements, individual ones of these properties and/or operating states can be exempted from this restoration process. For example, the position of the focusing apparatus can be ignored upon restoration in order to prevent any collision with the specimen. Likewise, based on an application requirement, opening of the fluorescence shutter can be ignored in order to prevent bleaching of the specimen.

It is also known that additional information can be artificially superimposed on the image in at least one microscope output. In the simplest case, these are reticles with a fixed pattern. More modern apparatuses also enable the superimposition of modifiable information. In the transmitted-light method, this can be done by means of a liquid crystal display (with no backlighting). By controlled activation of individual image points, the image is locally darkened and information can be overlaid as a shadow image. Selective reflecting-in of image points by means of a homogeneously illuminated micromirror matrix is also possible. In addition to the already-known bar patterns of variable size, these can also be measurement bars with a scale graduation matched to the object field. Reference is made to the Applicant's DE 102 26 275 A1 regarding the superimposition of measurement bars on images, and to the Applicant's DE 102 42 628 A1 regarding size calibration of a camera.

Information and operating states of the apparatuses for image generation and image acquisition, and of the illumination apparatus(es), can also be presented. Both a predetermined presentation of the information, and a presentation freely configurable by the user, are known. Also known is the fact that further information can be overlaid in the context of presentation of the image data (e.g. on a PC having suitable software). In addition to the operating states and properties of the apparatuses for image generation and acquisition, these can also be the previously described data that can be determined by the user. Because the resolution of the image data display is, as a rule, higher as compared with the system for overlaying into the apparatus for image generation, the information in the context of the image data display can be more complex or more comprehensive. If the image data display is a live-image display, the information displayed can be updated upon a change in content. For example, the scale of the image data can be adapted, with reference to the object field or to the length of a measurement bar, upon a change in magnification or a change in the operating mode of the apparatus for image acquisition. As a result, for example, an object in the object field can be measured directly on the live display of image data. If the object is a scale of known length, the latter can also be used to determine a correction value. This correction value can then be used for adaptation to the actual object-field size. The live display of the image data, having reticle masks adapted specifically to the object (nominal values and/or tolerances), can also be used as a gauge. The information thus overlaid can be stored as a separate object. In this case it is possible for individual information items, information groups, or all the information, to be reflected in or out at any time. Changes in the operating states and the properties of the apparatus for image generation and image production can be suppressed in order to prevent impermissible or unintentional manipulation. In this case only individual data, or all the data definable by the user, can be modified. In a further application instance, the information can be embedded into the image data. The information thus cannot be further modified at a later time. This additionally offers the advantage that the image data can be viewed in a standard software program, together with the additional information, with no knowledge of the form or content of the additional information.

Some applications in microscopy require a combination of image data that were generated in a context of different properties and operating states of the apparatus for image generation and/or image acquisition. For example, image data from two or more fluorescence images using excitation or viewing filters at different wavelengths are superimposed for display or storage. For superimposition, the individual image data can be colored after the fact. The differences in the characteristic features of the specimen can thereby be additionally intensified. Upon superimposition, the proportional brightness contributions of the individual images to the brightness of an image point of the superimposed image can be influenced by the user by means of a mixing factor.

Many of the topics addressed are dealt with in the user manuals for Leica application software, to which reference is expressly made here. These are the Online Help LAS EZ and Online Help LAS documents. The documents are supplied along with microscopes of the Applicant that are currently available. Descriptions of the Leica LAS module are stored in the files
P2943_Leica_Help_LAS_Module.pdf,
P2943_Leica_Help_LAS_Application.pdf,
P2943_Leica_Help_LAS_Core.pdf, and
P2943_Leica_Help_LAS_EZ.pdf,
   and are stored in openly accessible fashion at the Internet address ftp://patdoc:leica@ftp.leica.de/Patdoc/. The link indicated is intended to replace incorporation of these documents into the present Application.

The specimen region sensed in the form of image data by way of the apparatus for image generation and acquisition can be shifted by means of an XY stage. By moving the entire specimen to both sides or to one side, and subsequently assembling the respectively acquired individual images into one overall image, the specimen region of the apparatus for image generation can be artificially magnified. Assembly can occur on the basis of position data from the XY stage regarding the specimen region visible in the image data. This requires an XY stage of relatively high accuracy. In addition to use of the position data, the overall image can also be assembled by mutual comparison on the basis of characteristic features of the object in the image data of the individual images. This only possible, however, if those characteristic features are also present with sufficient contrast in the image data. By acquiring image data of the same specimen region with different focusing, each subregion of the specimen region having the greatest image sharpness can then be determined. A combination of these subregions yields image data that show the specimen in the entire object field with the best possible focus.

As a rule, the image sequences for these operations are generated by traveling to a specific position, halting at that position, and acquiring an image by way of the apparatus for image acquisition. It is likewise known to generate the image sequence by continuous positional displacement and use of a suitable synchronization signal for the apparatus for image acquisition. It is also known to adapt the positional displacement speed, at a constant image acquisition frequency of the apparatus for image acquisition, in such a way that the individual image data are suitably overlapped or serially arranged.

A complex image acquisition process in microscopy can encompass, for example, acquisition of an image stack in an axial direction for multiple positions of the specimen stage. An image that shows every part of the particular specimen region in focus is generated from each image stack. This image is also called a “multifocus” image (cf. in this regard the Applicant's EP 02 777 053.6). This is achieved by examining each individual image in the image stack for regions that are in focus. Those regions are then combined into one image. Once this multifocus image has been generated for each image stack for one position of the specimen stage, the images can be combined into one large-area image of the sample. This image shows many times the object field, and simultaneously has high resolution. The image acquisition process usually comprises traveling to a position with the specimen stage, stopping at that position, acquiring the image stack, and traveling to the next position, until the preselected specimen-stage region has been traversed. For this purpose, once sensing of the individual image is complete, the PC sends a control signal so that the focus drive can execute the next step in an axial direction or can move the stage drive to the next position. This is repeated for the pre-set focusing range (approximately equivalent to the specimen height) from a first to a second extreme position. Sensing of an individual image using the apparatus for image acquisition, and subsequent transfer of the image data, encompasses in each case an initialization phase that considerably slows down the process when there are many images in the image stack. Repeated traversal through the focusing range, and travel and deceleration at each step, likewise slow down the image acquisition process.

More recent apparatuses on microscopes allow continuous displacement of the focusing drive simultaneously with continuous sensing of image data at the highest possible speed (“free-running” mode). Transmission of a trigger signal from the camera to the focusing drive allows the latter to store the exact position during exposure of the image sensor, so that the position can later be associated with the corresponding image data. The displacement speed of the focusing drive must be selected, in this context, so that each two successive images show an image of an adjoining depth-of-focus region. The image sensor exposure time must also be adjusted to be sufficiently short that the focus for each image point does not change during exposure. The apparatus eliminates the initialization time for acquiring the image data of the individual images, and the delay involved in travel and deceleration for each step. The disadvantage that the specimen stage must be accelerated and then decelerated upon travel to each lateral position does remain. With a small object field and a large specimen-stage range to be traversed, this can have a considerable influence on the total imaging time.

### SUMMARY OF THE INVENTION

The object therefore exists of describing a microscope having microscope components, and a corresponding use of that microscope, that no longer exhibit the aforesaid disadvantages.

What is proposed according to the present invention is a microscope encompassing at least two components, each of the at least two components comprising at least one trigger interface configurable at least as an input and an output. A method for microscopy is furthermore proposed according to Claim 12. It should be made clear that the term “microscope” used here is also to be understood to mean so-called macroscopes, as well as systems that contain a microscope or macroscope.

According to the present invention, each trigger interface is configurable in principle as an input or an output, i.e. it exhibits both configuration capabilities, such that at any point in time at most one of the configuration capabilities is active. The microscope user thus has the capability of configuring each of the components, or its trigger interfaces, as an input or an output in accordance with present requirements; further configuration capabilities are within the scope of the invention.

This manner of achieving the object of the present invention enables flexible configuration of the microscope to meet a wide variety of requirements.

It is a matter of course also to equip a PC with a trigger interface of this kind, and to connect it to the microscope according to the present invention. Configuration and control of the microscope can thereby be simplified.

Usefully, at least one trigger interface of the at least two components is embodied so it can be switched off or configured as inactive. If a trigger interface is configured as inactive, it is thus configured as neither an input nor an output. In particular, all components of a microscope can be equipped in this fashion with trigger interfaces, any desired overall configuration of the microscope remaining settable for the user as a function of the intended application purpose.

Advantageously, the trigger interfaces of the at least two components are connected via a first data connection. The first data connection is referred to hereinafter as a trigger bus, synchronization bus, or signal bus for synchronization. The first data connection can comprise, in particular, at least two electrical data lines or one electrical data line having a common reference ground. It can likewise be embodied as an optical data line or as a radio transmission link.

According to a preferred embodiment, a synchronization signal is outputtable onto the first data connection from a trigger interface, configured as an output, of a component.

It is a matter of course that the synchronization signal is outputtable onto the first data connection from the interface, configured as an output, of a component at the beginning or end of an action of that component, after a freely definable delay time. The freely definable delay time can, in particular, also be defined as “zero,” so that the output occurs immediately at the beginning or end of the action.

Usefully, a synchronization signal on the first data connection is receivable by a trigger interface, configured as an input, of a component.

It is particularly advantageous that the synchronization signal received by a trigger interface, configured as an input, of a component initiates or terminates an action of that component, in particular after a freely definable delay time. It is understood that that freely definable delay time can also be defined as “zero.”

Advantageously, the action of the component encompasses switching over the configuration of that component and/or the configuration of the trigger interface of that component. The trigger interface can thus be switched over by means of a synchronization signal, in particular, from “input” to “output” or to “inactive,” etc. The configuration of the component itself is thus also advantageously modifiable. Lastly, the aforesaid delay time can also be modified thereby.

It is a matter of course if a digital signal, in particular having a TTL level, is used as a synchronization signal. Such a signal can be made available in simple fashion, and can be read in and evaluated by the receiving interface likewise in simple fashion.

Usefully, the at least two components are connected via a second data connection, a protocol-based signal, in particular a CAN, I2C, IEEE 1394, or RS232 signal being used for data transfer via the second data connection. The second data connection can be used in particular to configure the components and/or to configure the trigger interfaces and/or for data transfer, for example the transfer of control, image, and/or position data to or from a PC. An operating unit for the microscope can likewise be connected via the second data connection.

The first data connection can offer the advantage, in particular as compared with the second data connection, that it can be regarded as real-time-capable, and thus results in negligible delays in synchronization of the microscope components.

In a preferred embodiment of the invention, the at least two components are selected from a group that encompasses a microscope stage, focusing drive, zoom system, filter changer, and apparatus for image acquisition, in particular a camera.

Advantageously, the microscope encompasses a microscope stage, a focusing drive, and a camera, which are each equipped with at least one trigger interface.

The microscope according to the present invention is suitable in particular for carrying out a variety of microscopy methods.

In a method according to the present invention for microscopy, a microscope according to the present invention is used.

In a preferred embodiment, the at least two components are embodied as at least one driven, at least horizontally displaceable microscope stage; a driven focusing drive; and an apparatus for image acquisition, the method encompassing the following steps:
configuring the trigger interface of the apparatus for image acquisition as an output, so that a synchronization signal is outputted at the beginning of the acquisition of an image;
configuring the trigger interface of the microscope stage and of the focusing drive as an input, so that upon reception of a synchronization signal, the instantaneous position of the microscope stage and of the focusing drive is stored;
continuously moving the microscope stage;
continuously moving the focusing drive from a first focus position to a second focus position, with simultaneous acquisition of images by the apparatus for image acquisition.

Advantageously, the method further encompasses the steps of:
halting image acquisition when the second focus position is reached, and moving the focusing drive from the second focus position to the first focus position;
resuming continuous movement of the focusing drive from the first focus position to the second focus position, with simultaneous acquisition of images by the apparatus for image acquisition.

Advantageously, a microscope according to the present invention, configured as a stereomicroscope, is used to acquire an image stack in an axial direction. In stereomicroscopes, the beam axis is tilted with respect to the specimen plane, so that individual images in different focus planes appear laterally offset. Complex post-processing of the images is therefore usually necessary. By synchronously displacing the focusing drive for acquisition of an image stack, the lateral shifting of the individual images can already be avoided at acquisition.

Advantageously, a microscope according to the present invention is used to acquire an image stack in an axial direction for multiple different fluorescence excitations. The sequence of synchronization signals of the apparatus for image acquisition can additionally serve in this context to control the speed of the continuous movement of the filter changer. This can easily be done with a phase locked loop (PLL) circuit. For this, the synchronization signal from the trigger interface of the apparatus for image acquisition is forwarded to that circuit. In addition, the input delay of the trigger interface of the filter changer can be used to control the phase position.

Because the trigger interfaces of the microscope according to the present invention are freely configurable, these two methods can be carried out in combined fashion, or independently of one another, with the same microscope. Similar combinations can also be achieved using different illumination methods (e.g. different contrasting methods and variations in brightness level).

It is understood that the features recited above and those yet to be explained below can be used not only in the respective combination indicated, but also in other combinations or in isolation, without leaving the context of the present invention.

The invention is depicted schematically in the drawings on the basis of an exemplifying embodiment, and will be explained in detail below with reference to the drawings.

### BRIEF DESCRIPTION OF THE DRAWINGS

FIG. 1 schematically depicts a preferred embodiment of a microscope according to the present invention;

FIG. 2 schematically shows a configuration setting of multiple trigger interfaces of an embodiment of a microscope according to the present invention;

FIG. 3a shows the acquisition of an oblique image stack by simultaneous, continuous displacement of a microscope stage and focusing drive, according to an embodiment of a method according to the present invention;

FIG. 3b shows the acquisition of multiple oblique image stacks, in accordance with a preferred embodiment of a method according to the present invention; and

FIG. 4 shows the acquisition of an image stack by simultaneous, continuous displacement of a microscope stage and focusing drive, in accordance with an embodiment of a method according to the present invention in the context of a stereomicroscope.

### DETAILED DESCRIPTION OF THE DRAWINGS

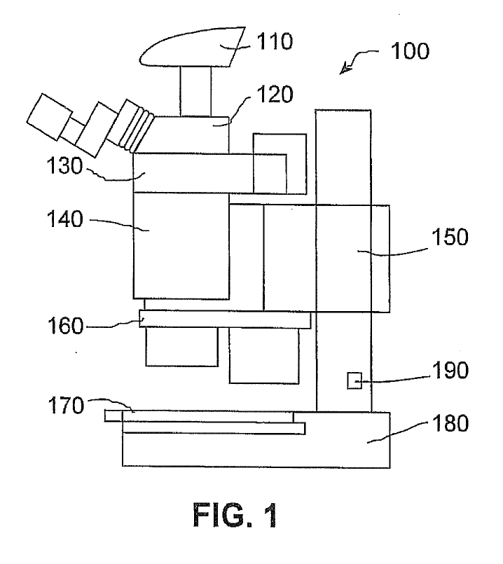

FIG. 1 schematically depicts a preferred embodiment of a microscope (microscope system) according to the present invention, labeled 100 in its entirety. The microscope has an apparatus for image acquisition embodied as a digital camera 110, which is mounted on a tube 120. Located below tube 120 is an (optional) fluorescence axis 130 and, adjacent thereto, a zoom system 140. Microscope 100 is furthermore equipped with a focusing drive 150. Located below zoom system 140 is an objective changer 160. The microscope further comprises a horizontally displaceable microscope stage, embodied as XY stage 170, that is arranged on a transmitted-light base 180. Lastly, the microscope comprises a data interface 190 that is suitable, for example, for connection to a computer, an operating unit, or the like. Data interface 190 is preferably operated by means of a data bus such as, for example, RS-232, RS-422, CAN, IEEE 1394, I2C.

Advantageously, microscope components 110 to 180 just described are each equipped with at least one trigger interface. The trigger interface is embodied to be configurable as an input and an output, and furthermore to be configurable as inactive.

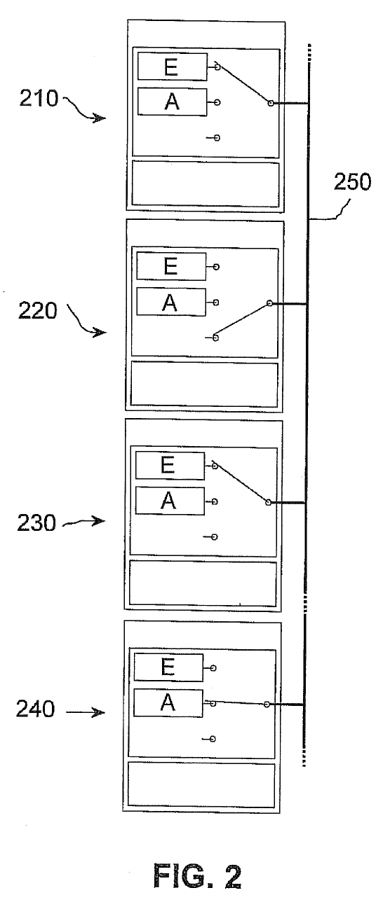

FIG. 2 schematically depicts multiple trigger interfaces 210 to 240. The trigger interfaces are connected via a first data connection 250 that, for example, can be embodied as an electrical data connection. The schematic depiction encompasses different configuration states of trigger interfaces 210 to 240. In accordance with the example depicted, trigger interfaces 210 and 230 are configured as an input “E”. Trigger interface 220 is configured as inactive, and trigger interface 240 is configured as an output “A”.

With the configuration depicted, a synchronization signal is outputted by trigger interface 240 onto data connection 250 and is received by trigger interfaces 210 and 230 via data connection 250. Because trigger interface 220 is configured as inactive, neither output nor reception of a synchronization signal occurs.

It is advantageously possible to change over the configuration of the trigger interfaces by way of a trigger signal. In the context of the configuration example just described, for instance, the component associated with trigger interface 240 can be configured in such a way that after output of a predetermined number N of synchronization signals, a reconfiguration of trigger interface 240 from output to input, or to inactive, takes place. The components associated with trigger interfaces 210 and 230, respectively, can likewise be configured in such a way that after reception of a predetermined number M of synchronization signals, a reconfiguration of trigger interfaces 210 and 230 from input to output, or to inactive, takes place.

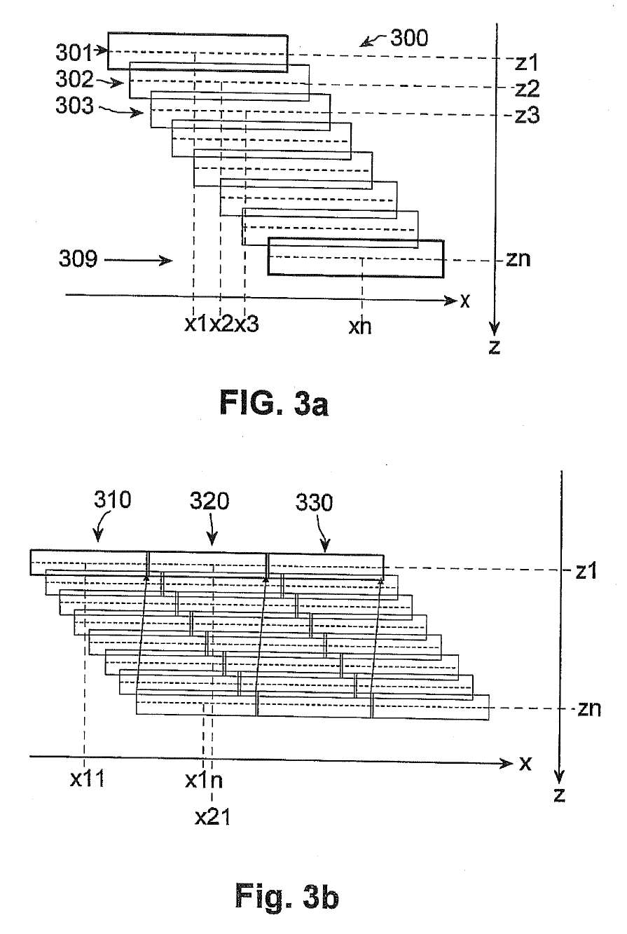

FIGS. 3a and 3b are described below in overlapping fashion. FIG. 3a depicts the imaging of an oblique image stack 300 by simultaneous, continuous displacement of a microscope stage and focusing drive, in accordance with an embodiment of a method according to the present invention.

Referring to FIG. 1 by way of example, in order to carry out this method, the trigger interface of camera 110 is configured as an output. The trigger interfaces of stage 170 and of focusing drive 150 are configured as an input. All the other trigger interfaces are configured as inactive. It is understood that the method is not limited to implementation on a microscope in accordance with FIG. 1.

The configuration of the camera is selected in such a way that at the beginning of the exposure time, a synchronization signal is outputted from the trigger interface onto the data connection. The configurations of the stage and of the focusing drive are selected in such a way that an incoming synchronization signal initiates storage of the respective current position with no relevant time delay. These positions can later be read out by the PC, for example via the communication interface of each component of the microscope, and allocated to the corresponding image data.

This operation can be carried out with any time delay and with no stringent requirements regarding transfer speed.

The method starts with acquisition of an individual image 301 at a first focus position z1 and a first position x1 of the stage. The trigger interface of the camera subsequently, at the beginning of each exposure time for the acquisition of images 302, 303, . . . , outputs a synchronization signal to the data connection, which signal initiates storage of positions x2, x3, . . . , z2, z3, . . . . With the acquisition of individual image 309 upon reaching a second focus position zn, acquisition of image stack 300 is complete.

The speed of the axis of the specimen stage should preferably be set so that the object fields of the image at first position z1 of the focusing drive and at second position zn overlap slightly (stage at x1 and xn, respectively).

During this particularly preferred expanded image data sensing process, not only does the focusing drive travels in the direction of axis z, but the stage also travels continuously in the direction of axis x. Oblique image stacks 300, 310, 320, 330, etc. are produced, which can be correspondingly evaluated.

As shown in FIG. 3b, the speed of the axis of the specimen stage should preferably be set so that the object fields of the image at first position z1 of the focusing drive, and at second position zn, overlap slightly (stage at x11 and x1n, respectively), and the object fields of adjacent images at any position of the focusing drive (e.g. z1) adjoin one another (e.g. stage at x11 and x21, respectively). The overlap is defined by the time required to return the focusing drive from position zn to position z1, multiplied by the displacement speed (in this case in the X direction) of the specimen stage. This return is performed at maximum speed.

To ensure that no additional image data are produced during this return operation, the trigger interfaces of the microscope components advantageously also possess the capability of switching over their configuration on the basis of a synchronization signal. In the present case this means that the number of images in an image stack 310, 320, 330 must be known; this is usually ensured by presetting.

Once the trigger interface of the camera has sent out that number of synchronization signals, it is configured as an input. The configuration of the trigger interface of the camera is selected in such a way that an incoming synchronization signal initiates a reconfiguration as an output. The trigger interface of the focusing drive is configured as an output, and the interface sends out a synchronization signal as soon as the first focusing position has been reached again. This synchronization signal switches the configuration of the trigger interfaces, and of the components, back into the original configuration, and the next image stack can be acquired.

In addition to the time saved because acceleration and deceleration of the specimen stage is no longer necessary, mechanical characteristics that would otherwise have a negative effect on the quality of the result are also minimized. These are, in particular, vibrations of the specimen stage after deceleration, and inaccuracies due to repeated positional control.

Although vertical return of the focus drive with subsequent travel in the opposite direction can lead to vibrations even in the context of the method described using the apparatus according to the present invention, those vibrations (in contrast to displacement of the specimen stage) occur not in a lateral direction but of course principally in an axial direction. Because the camera possesses sufficient depth of focus, vibrations in this region result in much less image disruption. If the vibrations are greater, it is additionally advantageous to travel beyond the first position of the focusing drive when returning, and to utilize this run-up distance for transients and vibration decay. Because transient and decay behavior is usually defined and measured by way of corresponding times, it may be advantageous to stipulate those times directly to the trigger interfaces. The trigger interface advantageously possesses for that purpose the capability of defining an input and output delay. In the present example, this can serve to switch over the configuration of the trigger interface. This switchover takes place once an input delay time has elapsed; the synchronization signal that represents the end of the return travel constitutes the starting point for the input delay time.

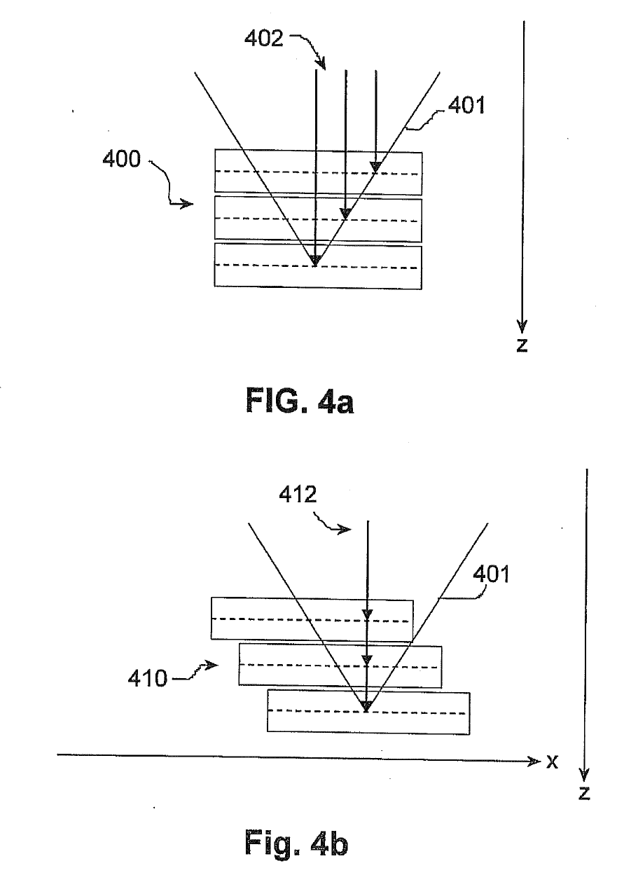

FIG. 4a depicts acquisition of an image stack 400 using a stereomicroscope of the existing art. Stereomicroscopes have the property that the focusing direction and the observation beam path do not extend parallel. In the example shown, observation beam 401 therefore proceeds at an angle to focusing direction 402.

When the focusing drive is then displaced in direction Z in order to acquire image stack 400, this leads to a horizontal displacement of the particular individual images being viewed. A displacement in the Z direction thus results in a horizontal shift of the individual images.

FIG. 4b depicts the acquisition of an image stack 410 carried out using a microscope according to the present invention. The trigger interfaces of the microscope components are configured in the same way as for the method described in FIGS. 3a and 3b. The speed of the specimen stage in direction X is set so that the lateral displacement due to focus change is corrected. Subsequent laborious correction of the individual images can thereby be avoided, since observation beams 401 are now each directed toward the same X position of the sample.

The right is reserved to claim protection independently for the concretely recited embodiments of the invention.

It is understood that only particularly preferred embodiments of the invention are presented in the Figures that are depicted. Other embodiments of the invention are additionally conceivable without leaving the scope of this invention.

### List of Component Parts

100 Microscope
110 Digital camera
120 Tube
130 Fluorescence axis
140 Zoom system
150 Focusing drive
160 Objective changer
170 XY stage
180 Transmitted-light base
190 Data interface
210 to 240 Trigger interfaces
250 Data connection
300, 310, 320, 330 Image stack
301, 302, 303, 309 Individual image
x1, x2, x3, xn, x11, x1n, x21 X position
z1, z2, z3, zn Z position
400, 410 Image stack
401 Illumination beam path
402, 412 Observation beam paths

1. A microscope comprising at least two components, wherein each of the at least two components comprises at least one trigger interface, and each of the at least one interfaces is configurable at least as an input and an output.

2. The microscope according to claim 1, comprising means for configuring the at least one trigger interface of the at least two components as inactive.

3. The microscope according to claim 1, wherein the at least one trigger interfaces of the at least two components are connected to each other via a first data connection.

4. The microscope according to claim 3, comprising means for outputting a synchronization signal onto the first data connection via a trigger interface that is configured as an output of one of the components.

5. The microscope according to claim 4, comprising means for outputting the synchronization signal onto the first data connection from a component at the beginning or end of an action of that component after a freely definable delay time.

6. The microscope according to claim 3, comprising means for receiving a synchronization signal on the first data connection by a trigger interface of one of the components, said trigger interface being configured as an input.

7. The microscope according to claim 6, comprising means for initiating or terminating an action of said component after a freely definable delay time by the synchronization signal received by the trigger interface configured as an input.

8. The microscope according to claim 7, wherein the action of the component is switching the configuration of that component.

9. The microscope according to claim 7, wherein the action of the component is switching the configuration of the trigger interface of that component.

10. The microscope according to claim 4, wherein the synchronization signal is a digital signal.

11. The microscope according to claim 10, wherein the digital signal has a TTL level.

12. The microscope according to claim 1, wherein the at least two components are connected via a second data connection using a protocol-based signal for data transfer via the second data connection.

13. The microscope according to claim 1, wherein the at least two components are selected from a group consisting of: a microscope stage, a focusing drive, a zoom system, a filter changer, and an apparatus for image acquisition.

14. A microscopy method using a microscope comprising at least two components, wherein each of the at least two components comprises at least one trigger interface, and each of the at least one interfaces is configurable at least as an input and an output, wherein the at least two components of the microscope are selected from a group consisting of: at least one driven, at least horizontally displaceable microscope stage; a driven focusing drive; and an apparatus for image acquisition, the microscopy method comprising the following method steps:
configuring the trigger interface of the apparatus for image acquisition as an output so that a synchronization signal is outputted upon acquisition of an image;
configuring the trigger interface of the microscope stage and of the focusing drive as an input so that upon receiving a synchronization signal the instantaneous position of the microscope stage and of the focusing drive is stored;
continuously moving the microscope stage;
continuously moving the focusing drive from a first focus position to a second focus position while simultaneously acquiring images by means of the apparatus for image acquisition.

15. The method according to claim 14, further comprising the method steps of:
halting image acquisition when the second focus position is reached and moving the focusing drive from the second focus position to the first focus position;
resuming continuous movement of the focusing drive from the first focus position to the second focus position while simultaneously acquiring images by the apparatus for image acquisition.
